(19) United States
(12) Patent Application Publication
(10) Pub. No.: US 2026/0316260 A1
(43) Pub. Date: Oct. 15, 2026

(54) METHOD FOR CONTROLLING PLURALITY OF ROBOTS, DEVICE THAT CONTROLS PLURALITY OF ROBOTS, AND SYSTEM THAT CONTROLS PLURALITY OF ROBOTS

(71) Applicant: SONY GROUP CORPORATION, TOKYO (JP)

(72) Inventors: HIROKI SAIJO, TOKYO (JP); YOSHINAO SODEYAMA, TOKYO (JP); TAKARA KASAI, TOKYO (JP); WATARU KOKUBO, TOKYO (JP)

(21) Appl. No.: 18/880,857

(22) PCT Filed: Jul. 20, 2023
(86) PCT No.: PCT/JP2023/026552

§ 371 Date: Jan. 3, 2025

(30) Foreign Application Priority Data
Jul. 22, 2022 (JP) 2022-117370

(51) Int. Cl. B25J 9/00; B25J 9/16

(52) U.S. Cl. CPC B25J 9/0084; B25J 9/1661

(57) ABSTRACT

A method for controlling a plurality of robots to enable one operator to control the plurality of robots is provided.

A method for controlling a plurality of robots according to the present disclosure includes: a step of receiving an operation command for the plurality of robots from an operator; a step of using a plurality of robot models and an environment model corresponding the plurality of robots, causing the plurality of robot models to operate in the environment model at a higher speed than actual time on the basis of the operation command, and acquiring a predicted observation value obtained as a result; a step of displaying the predicted observation value toward the operator; a step of accumulating task information including the operation command and the predicted observation value; and a step of transmitting the accumulated task information to the plurality of robots.

### TECHNICAL FIELD

The present disclosure relates to a method for controlling a plurality of robots, a device that controls a plurality of robots, and a system that controls a plurality of robots.

### BACKGROUND ART

The use of robots in service fields such as housework, nursing care, and physical assistance is being promoted these days. In such fields, a plurality of robots is often operated simultaneously in a single work environment. Further, in a situation where it is difficult for a robot to autonomously execute all tasks, a robot that is remotely controlled by an operator is often used (see Patent Document 1, for example). However, a control system in which one robot occupies one operator is inefficient in terms of cost.

### CITATION LIST

### Patent Document

Patent Document 1: Japanese Patent Application Laid-Open No. H9-254065

### SUMMARY OF THE INVENTION

### Problems to be Solved by the Invention

The present disclosure is to solve the above problem, and aims to provide a control method for a plurality of robots, a control device for a plurality of robots, and a control system for a plurality of robots, with which a plurality of robots can be controlled by one operator.

### Solutions to Problems

To solve the above problems, a method for controlling a plurality of robots according to the present disclosure includes: a step of receiving an operation command for the plurality of robots from an operator; a step of using a plurality of robot models and an environment model corresponding the plurality of robots, causing the plurality of robot models to operate in the environment model at a higher speed than actual time on the basis of the operation command, and acquiring a predicted observation value obtained as a result; a step of displaying the predicted observation value toward the operator; a step of accumulating task information including the operation command and the predicted observation value; and a step of transmitting the accumulated task information to the plurality of robots.

Further, a device that controls a plurality of robots according to the present disclosure includes: an input unit that receives an operation command for a plurality of robots from an operator; a simulation unit that includes a plurality of robot models and an environment model corresponding to the plurality of robots, causes the plurality of robot models to operate in the environment model at a higher speed than actual time on the basis of the operation command, and outputs a predicted observation value obtained as a result; a display unit that displays the predicted observation value toward the operator; an accumulation unit that accumulates task information including the operation command and the predicted observation value; and a transmission unit that transmits the task information accumulated in the accumulation unit to the plurality of robots.

Furthermore, a system that controls a plurality of robots according to the present disclosure includes: the plurality of robots; and a control device for the plurality of robots, in which the control device includes: an input unit that receives an operation command for the plurality of robots from an operator; a simulation unit that includes a plurality of robot models and an environment model corresponding to the plurality of robots, simulates an operation of the plurality of robot models in the environment model at a higher speed than actual time on the basis of the operation command, and outputs a predicted observation value obtained as a result; a display unit that displays the predicted observation value toward the operator; a first accumulation unit that accumulates task information including the operation command and the predicted observation value; and a transmission unit that transmits the task information accumulated in the first accumulation unit to the plurality of robots, and each robot of the plurality of robots includes: a reception unit that receives the task information from the control device; a second accumulation unit that accumulates the task information received by the reception unit; and a control unit that causes the robot to operate in an actual environment, in accordance with the operation command included in the task information accumulated in the second accumulation unit.

### BRIEF DESCRIPTION OF DRAWINGS

FIG. 1 is a diagram illustrating the configuration of a control system for a plurality of robots according to a first embodiment.

FIG. 2 is a diagram illustrating specific configurations of a control device and robots according to the first embodiment.

FIG. 3 is a diagram illustrating logical configurations of simulators and accumulation units according to the first embodiment.

FIG. 4 is a diagram illustrating logical configurations of robots and accumulation units according to the first embodiment.

FIG. 5 is a flowchart for explaining operations of the control system for a plurality of robots according to the first embodiment.

FIG. 6 is a timing chart illustrating transmission and execution of task information from the control device to the robots.

FIG. 7 is a table showing an example of definitions of environmental complexities.

FIG. 8 is a diagram illustrating a configuration in which simulators and robots have one-to-one correspondence.

FIG. 9 is a diagram illustrating a configuration in which simulators and robots have one-to-N correspondence.

FIG. 10 is a table showing an example of definitions of parameters for an autonomous driving robot.

FIG. 11 is tables showing examples of calculation of a maximum value of a shortening rate in the autonomous driving robot.

### MODE FOR CARRYING OUT THE INVENTION

In the description below, embodiments of the present disclosure will be explained with reference to the drawings. In the drawings, the same or corresponding elements are denoted by the same reference signs, and detailed explanation thereof will not be repeated as appropriate.

### First Embodiment

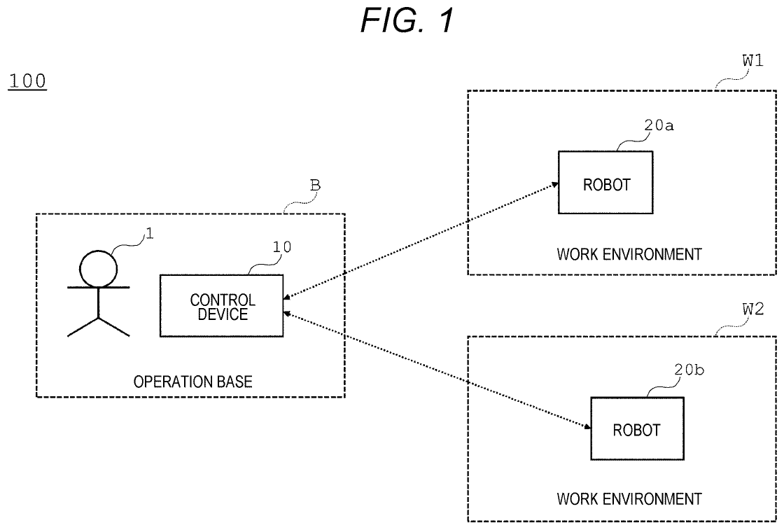

FIG. 1 is a diagram illustrating the configuration of a control system 100 for a plurality of robots according to a first embodiment of the present disclosure. The control system 100 includes a control device 10 that is operated by an operator 1, and two robots 20a and 20b that are controlled by the control device 10. The control device 10 is disposed in an operation base B. The robot 20a is disposed in a work environment W1, and the robot 20b is disposed in a work environment W2. The operation base B and the work environments W1 and W2 are normally assumed to be at separate places, but may be at the same place.

The control device 10 and the robot 20a can communicate with each other via wireless communication. Likewise, the control device 10 and the robot 20b can communicate with each other via wireless communication. The operator 1 can control the robots 20a and 20b by operating the control device 10. In other words, the operator 1 can control the robots 20a and 20b via the control device 10.

The robots 20a and 20b are not limited to any particular kind, but are manipulator robots to be used for housework support at home as an example. Note that the number of robots to be controlled by the control device 10 is not necessarily two, but may be three or larger. Further, a plurality of robots may be present in one work environment.

### (Configuration of the Control Device)

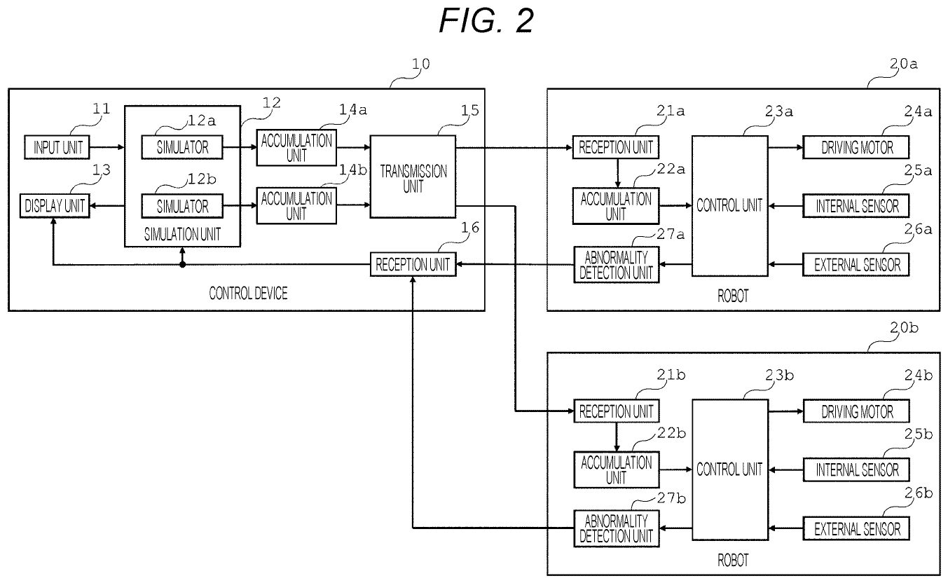

FIG. 2 is a diagram illustrating specific configurations of the control device 10 and the robots 20a and 20b. The control device 10 includes an input unit 11, a simulation unit 12, a display unit 13, accumulation units 14a and 14b, a transmission unit 15, and a reception unit 16.

The input unit 11 is formed with a keyboard or a mouse or the like, for example, and receives an operation command from the operator 1 to the robots 20a and 20b. Specific examples of the operation command relate to forward movement, backward movement, direction change, acceleration, deceleration, and the like of the robot.

The simulation unit 12 is formed with a personal computer or the like, for example. The simulation unit 12 simulates operations of the robots 20a and 20b, on the basis of the operation command to the robots 20a and 20b received from the operator 1 via the input unit 11. Specifically, the simulation unit 12 includes a simulator 12a that simulates an operation of the robot 20a, and a simulator 12b that simulates an operation of the robot 20b.

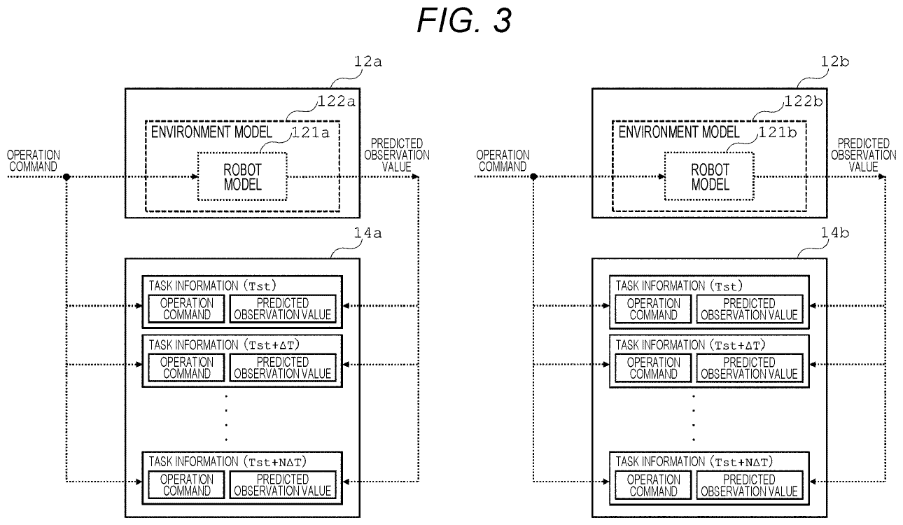

FIG. 3 is a diagram illustrating logical configurations of the simulators 12a and 12b, and the accumulation units 14a and 14b, which will be described later. The simulator 12a includes a robot model 121a corresponding to the robot 20a, and an environment model 122a corresponding to the work environment W1. Likewise, the simulator 12b includes a robot model 121b corresponding to the robot 20b, and an environment model 122b corresponding to the work environment W2.

The simulator 12a operates the robot model 121b in the environment model 122a at a higher velocity than actual time on the basis of an operation command from the operator 1, and outputs a predicted observation value obtained as a result. Specific examples of the predicted observation value include internal information such as the position, velocity, and acceleration of the robot model 121a, and external information such as the position, velocity, and acceleration of an obstacle existing around the robot model 121a.

Likewise, the simulator 12b operates the robot model 121b in the environment model 122b at a higher velocity than actual time on the basis of an operation command from the operator 1, and outputs a predicted observation value obtained as a result. Specific examples of the predicted observation value include internal information such as the position, velocity, and acceleration of the robot model 121b, and external information such as the position, velocity, and acceleration of an obstacle existing around the robot model 121b.

In the environment models 122a and 122b, the robot models 121a and 121b operate faster than actual time. Specifically, where the actual time, which is the time that actually elapses in the actual environment, is represented by Treal, and the simulation time that elapses in the environment model is represented by Tsim, the following relationship is established between the two.

$$Shortening rate Kscale = Tsim / Treal$$

In the above equation, the shortening rate Kscale is a real number of 1 or greater. For example, in a case where the shortening rate Kscale=10, when a simulation time of 100 seconds has elapsed in the environment model, only 10 seconds have elapsed in actual time.

Referring back to FIG. 2, the display unit 13 is formed with a liquid crystal display or the like, for example. The display unit 13 displays, toward the operator 1, the predicted observation value that corresponds to the robot 20a and is output from the simulator 12a, and the predicted observation value that corresponds to the robot 20b and is output from the simulator 12b. The time that is felt by the operator 1 is the actual time. Accordingly, in a case where the shortening rate Kscale=10, for example, the operator 1 can feel the simulation time elapsing at the rate of 1/10 of the actual time in the environment model. Therefore, in principle, the operator 1 can simultaneously operate up to 10 robot models in an environment model.

The accumulation units 14a and 14b are formed with memory devices or the like, for example. The accumulation unit 14a accumulates task information corresponding to the robot 20a, including an operation command from the operator 1, a predicted observation value obtained as a result of operating the robot model 121a in the environment model 122a on the basis of the operation command, and time information in the environment model 122a (see FIG. 3). Likewise, the accumulation unit 14b accumulates task information related to the robot 20b, including an operation command from the operator 1, a predicted observation value obtained as a result of operating the robot model 121b in the environment model 122b on the basis of the operation command, and time information in the environment model 122b (see FIG. 3).

In FIG. 3, the task information accumulated first in the accumulation unit 14a is the task information at time Tst in the environment model 122a. The task information accumulated second is the task information at time Tst+ΔT in the environment model 122a. The Nth accumulated task information is the task information at time Tst+NΔT in the environment model 122a. Here, ΔT represents the time that elapses in the environment model 122a, which is the simulation time.

Likewise, the task information accumulated first in the accumulation unit 14b is the task information at time Tst in the environment model 122b. The task information accumulated second is the task information at time Tst+ΔT in the environment model 122b. The Nth accumulated task information is the task information at time Tst+NΔT in the environment model 122b. Here, ΔT represents the time that elapses in the environment model 122b, which is the simulation time.

Referring back to FIG. 2, the transmission unit 15 is formed with a wireless communication interface or the like, for example, and collectively transmits the task information accumulated in the accumulation unit 14a to the corresponding robot 20a. The transmission unit 15 also collectively transmits the task information accumulated in the accumulation unit 14b to the corresponding robot 20b.

The reception unit 16 is formed with a wireless communication interface and the like, for example, and receives, from the robot 20a or 20b, abnormality detection information that will be described later. The display unit 13 displays, toward the operator 1, the abnormality detection information received by the reception unit 16.

### (Configuration of a Robot)

Next, the configurations of the robots 20a and 20b are described. However, the robots 20a and 20b have the same configuration, the robot 20a is described herein. The robot 20a includes a reception unit 21a, an accumulation unit 22a, a control unit 23a, a driving motor 24a, an internal sensor 25a, an external sensor 26a, and an abnormality detection unit 27a.

The reception unit 21a is formed with a wireless communication interface or the like, for example, and collectively receives task information transmitted from the control device 10. This task information has been accumulated in the accumulation unit 14a of the control device 10.

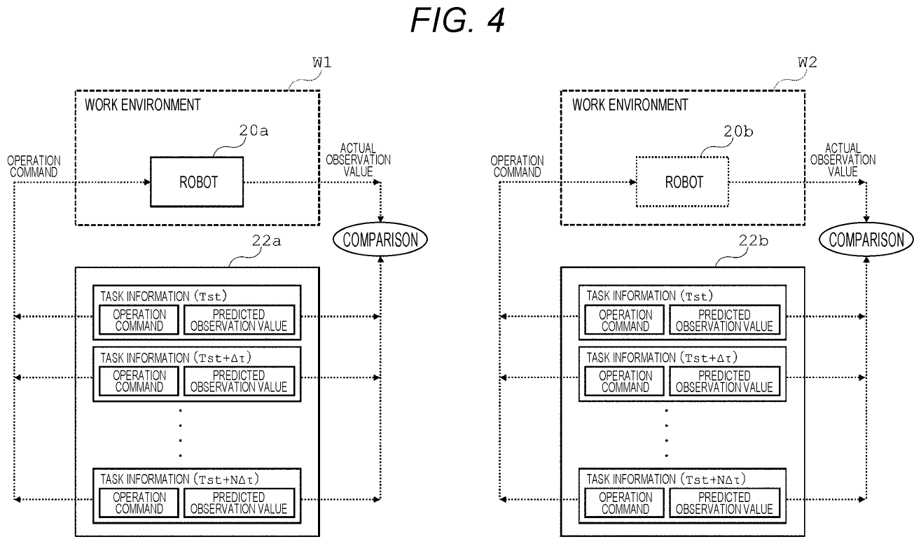

The accumulation unit 22a is formed with a memory device or the like, for example, and accumulates the task information collectively received by the reception unit 21a. FIG. 4 is a diagram illustrating the robots 20a and 20b in the work environments, which are the actual environments, and logical configurations of the accumulation units 22a and 22b thereof.

In FIG. 4, the task information accumulated first in the accumulation unit 22a is the task information at time Tst in the actual environment. The second accumulated task information is the task information at time Tst+Δτ in the actual environment. The Nth accumulated task information is the task information at time Tst+NΔτ in the actual environment. Here, time Tst in the actual environment is equal to time Tst in the environment model. Further, Δτ represents time that elapses in the actual environment, which is actual time, and the relationship expressed by Δτ=Ksacle·ΔT holds.

Referring back to FIG. 2, the control unit 23a is formed with a microcomputer or the like, for example. The control unit 23a reads the task information accumulated in the accumulation unit 22a, and controls the driving motor 24a and the like in accordance with the operation command included in the task information, to control operations of the robot 20a in the actual environment, which is the work environment W1 (see FIG. 4). Specific examples of operations of the robot 20a include forward movement, backward movement, direction change, acceleration, deceleration, and the like of the robot 20a.

Further, the control unit 23a acquires actual observation values obtained as a result of operations of the robot 20a, via the internal sensor 25a and the external sensor 26a. Specific examples of actual observation values include internal information such as the position, velocity, and acceleration of the robot 20a, and external information such as the position, velocity, and acceleration of an obstacle existing around the robot 20a.

The abnormality detection unit 27a is formed with a microcomputer or the like, for example. The abnormality detection unit 27a detects a difference between a predicted observation value and an actual observation value, which is an abnormality, on the basis of a comparison between the predicted observation values included in the task information and the actual observation values acquired via the internal sensor 25a and the external sensor 26a (see FIG. 4). For example, in a case where a difference between the position and the velocity of an obstacle in the surroundings in the predicted observation values and the position and the velocity of the obstacle in the surroundings in the actual observation values is equal to or larger than a predetermined threshold, the difference is determined to be abnormal. In a case where the abnormality detection unit 27a has detected an abnormality, the abnormality detection unit 27a transmits abnormality detection information including details of the abnormality to the control device 10 via wireless communication.

### (Operations of the Control System)

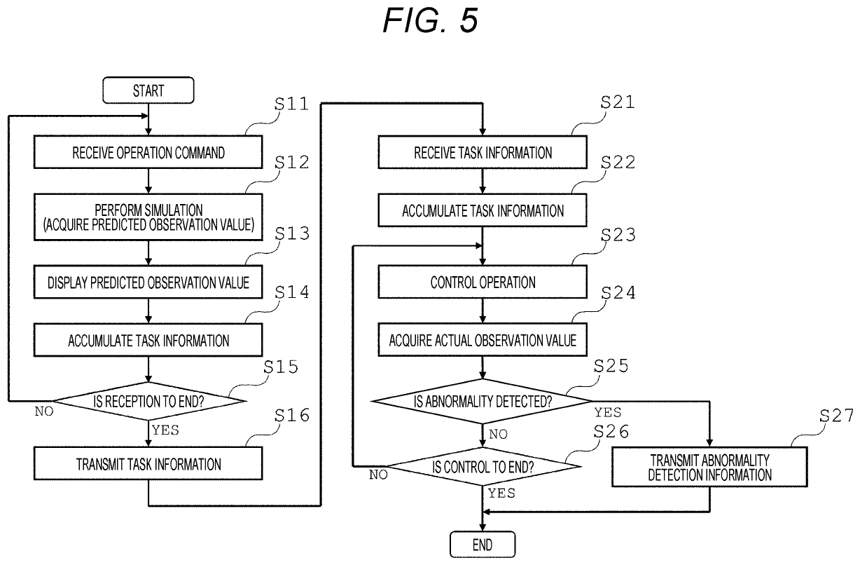

Next, operations of the control system 100 for a plurality of robots according to the first embodiment are described with reference to a flowchart shown in FIG. 5. Operations of the control system 100 are divided into an operating phase of steps S11 to S16 to be carried out by the control device 10, and an executing phase of steps S21 to S27 to be carried out by the robots 20a and 20b.

In step S11 of the executing phase, the input unit 11 of the control device 10 receives one operation command that is from the operator 1 to the robot 20a. Also, the input unit 11 of the control device 10 receives one operation command that is from the operator 1 to the robot 20b.

In step S12, the simulation unit 12 of the control device 10 simulates operations of the robots 20a and 20b at a higher velocity than actual time, on the basis of the operation commands received in step S11 described above. Specifically, the simulator 12a operates the robot model 121a faster than actual time in the environment model 122a on the basis of one operation command, and outputs one predicted observation value obtained as a result. Likewise, the simulator 12b operates the robot model 121b in the environment model 122b faster than actual time on the basis of one operation command, and outputs one predicted observation value obtained as a result.

In step S13, the display unit 13 of the control device 10 displays, toward the operator 1, the one predicted observation value corresponding to the robot 20a and the one predicted observation value corresponding to the robot 20b as output in step S12 described above.

In step S14, the accumulation unit 14a of the control device 10 accumulates one set of task information, including the one operation command for the robot 20a received in step S11 described above, the one predicted observation value corresponding to the robot 20a output as a result of the one operation command in step S12 described above, and time information in the environment model 122a. Likewise, the accumulation unit 14b of the control device 10 accumulates one set of task information, including the one operation command for the robot 20b received in step S11 described above, the one predicted observation value corresponding to the robot 20b output as a result of the one operation command in step S12 described above, and time information in the environment model 122b.

In step S15, the input unit 11 of the control device 10 determines whether operation commands are successively received from the operator 1. If operation commands are successively received from the operator 1 (S15=NO), the operation returns to step S11 described above, and, if not (S15=YES), the operation moves on to step S16.

In step S16, the transmission unit 15 of the control device 10 collectively transmits the task information accumulated in the accumulation unit 14a to the corresponding robot 20a. Also, the transmission unit 15 of the control device 10 collectively transmits the task information accumulated in the accumulation unit 14b to the corresponding robot 20b. At this point, the operating phase to be carried out by the control device 10 comes to an end, and the operation moves on to the executing phase to be carried out by the robots 20a and 20b.

In step S21 of the executing phase, the reception unit 21a of the robot 20a collectively receives the task information from the control device 10. Likewise, the reception unit 21b of the robot 20b collectively receives the task information from the control device 10.

In step S22, the accumulation unit 22a of the robot 20a accumulates the task information collectively received in step S21 described above. At this point of time, the time information Tst+nΔT in the environment model 122a included in the task information is converted into the time information Tst+nΔτ in the actual environment. Here, n represents a natural number of 0 to N, and the relationship expressed as Δτ=Kscale·ΔT holds.

Likewise, the accumulation unit 22b of the robot 20b accumulates the task information collectively received in step S21 described above. At this point of time, the time information Tst+nΔT in the environment model 122b included in the task information is converted into the time information Tst+nΔτ in the actual environment. Here, n represents a natural number of 0 to N, and the relationship expressed as Δτ=Kscale·ΔT holds.

In step S23, the control unit 23a of the robot 20a extracts one set of task information from the accumulation unit 22a, and controls the driving motor 24a and the like in accordance with one operation command included in the one set of task information, to control the operations of the robot 20a in the actual environment, which is the work environment W1. Specific examples of operations of the robot 20a include forward movement, backward movement, direction change, acceleration, deceleration, and the like of the robot 20a.

Likewise, the control unit 23b of the robot 20b extracts one set of task information from the accumulation unit 22b, and controls the driving motor 24b and the like in accordance with one operation command included in the one set of task information, to control the operations of the robot 20b in the actual environment, which is the work environment W2. Specific examples of operations of the robot 20b include forward movement, backward movement, direction change, acceleration, deceleration, and the like of the robot 20b.

In step S24, the control unit 23a of the robot 20a acquires one actual observation value obtained as a result of the operation in step S23 described above, via the internal sensor 25a and the external sensor 26a. Specific examples of the one actual observation value include internal information such as the position, velocity, and acceleration of the robot 20a, and external information such as the position, velocity, and acceleration of an obstacle existing around the robot 20a.

Likewise, the control unit 23b of the robot 20b acquires one actual observation value obtained as a result of the operation in step S23 described above, via the internal sensor 25b and the external sensor 26b. Specific examples of the one actual observation value include internal information such as the position, velocity, and acceleration of the robot 20b, and external information such as the position, velocity, and acceleration of an obstacle existing around the robot 20b.

In step S25, the abnormality detection unit 27a of the robot 20a determines the difference between the predicted observation value and the actual observation value, or determines the presence or absence of an abnormality, on the basis of a comparison between the one predicted observation value included in the one set of task information extracted in step S23 described above and the one actual observation value acquired in step S24 described above. For example, in a case where a difference between the position and the velocity of an obstacle in the surroundings in the predicted observation values and the position and the velocity of the obstacle in the surroundings in the actual observation values is equal to or larger than a predetermined threshold, the difference is determined to be abnormal.

If an abnormality is detected (S25=YES), the abnormality detection unit 27a transmits abnormality detection information including the details of the abnormality to the control device 10 via wireless communication (step S27), and the control on the robot 20a comes to an end (END). After that, the control on the robot 20a shifts to real-time control by the operator 1. As a result, the operator 1 can control an obstruction avoidance operation in real time, for example. If any abnormality is not detected (S25=NO), on the other hand, the operation moves on to step S26.

Likewise, the abnormality detection unit 27b of the robot 20b determines the difference between the predicted observation value and the actual observation value, or determines the presence or absence of an abnormality, on the basis of a comparison between the one predicted observation value included in the one set of task information extracted in step S23 described above and the one actual observation value acquired in step S24 described above. For example, in a case where a difference between the position and the velocity of an obstacle in the surroundings in the predicted observation values and the position and the velocity of the obstacle in the surroundings in the actual observation values is equal to or larger than a predetermined threshold, the difference is determined to be abnormal.

If an abnormality is detected (S25=YES), the abnormality detection unit 27b transmits abnormality detection information including the details of the abnormality to the control device 10 via wireless communication (step S27), and the control on the robot 20b comes to an end (END). After that, the control on the robot 20b shifts to real-time control by the operator 1. As a result, the operator 1 can control an obstruction avoidance operation in real time, for example. If any abnormality is not detected (S25=NO), on the other hand, the operation moves on to step S26.

In step S26, the control unit 23a of the robot 20a determines whether there is task information remaining in the accumulation unit 22a. If there is task information remaining in the accumulation unit 22a (S26=NO), the operation returns to step S23 described above. If the accumulation unit 22a is empty (S26=YES), the control on the robot 20a comes to an end (END).

Likewise, the control unit 23b of the robot 20b determines whether there is task information remaining in the accumulation unit 22b. If there is task information remaining in the accumulation unit 22b (S26=NO), the operation returns to step S23 described above. If the accumulation unit 22b is empty (S26=YES), the control on the robot 20b comes to an end (END).

As described above, the control system for a plurality of robots according to the first embodiment includes a plurality of robot models and environment models corresponding to the plurality of robots. The control device operates the plurality of robot models faster than actual time in the environment models on the basis of operation commands received from the operator for the plurality of robots, and acquires predicted observation values obtained as a result. The control device accumulates task information including the operation commands and the predicted observation values, and transmits the accumulated task information to the plurality of robots. With such characteristics, the control system according to the first embodiment can enable one operator to control the plurality of robots.

Each robot accumulates the task information received from the control device, and operates in the real environment in accordance with the operation command included in the accumulated task information. Thus, the influence of a communication delay between the control device and each robot can be minimized, compared with that in a case where the task information is sequentially transmitted from the control device to the respective robots.

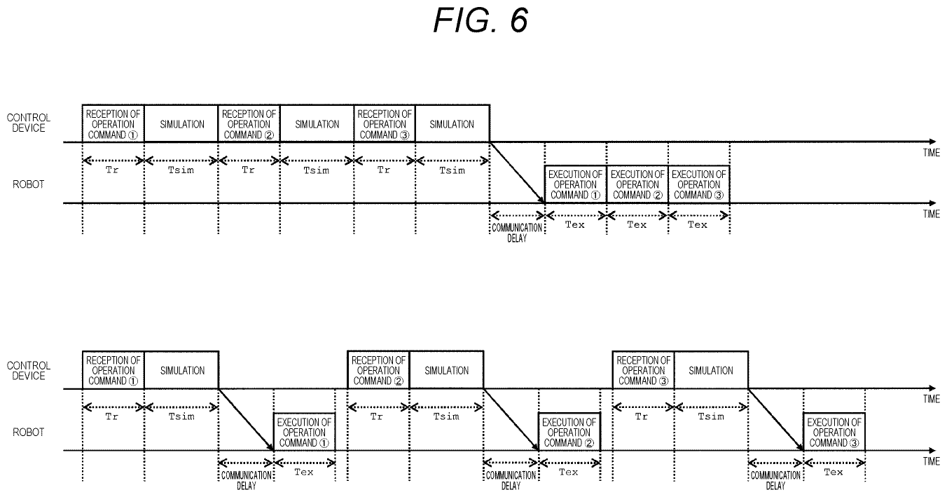

A timing chart on the upper side in FIG. 6 is a timing chart in which the control device collectively transmits and executes accumulated task information for the robots in the control system according to the first embodiment. A timing chart on the lower side in FIG. 6 is a timing chart in which the control device sequentially transmits and executes task information for the robots, as is seen in conventional techniques. As is apparent from a comparison between the two, the control system according to the first embodiment can minimize the influence of a communication delay between the control device and a robot.

Each robot acquires an actual observation value obtained as a result of an operation in the actual environment, and detects an abnormality on the basis of a comparison between a predicted observation value and the actual observation value. As a result, each robot can detect a difference between a predicted observation value and an actual observation value, which is an abnormality, in real time.

In a case where an abnormality is detected, control on the robot in which the abnormality is detected shifts to real-time control by the operator. Thus, the operator can control the robot in real time at the time of the abnormality detection.

A relationship expressed as shortening rate Kscale=Tsim/Treal holds between the actual time Treal, which is felt by the operator, and the simulation time Tsim, which elapses in the environment model, and the shortening rate Kscale is a real number of 1 or greater. Thus, the operator can feel the simulation time that elapses in the environment model, as the time in 1/Kscale. For example, in a case where the shortening rate Kscale=10, the time required for the operator to spend to operate one robot model for 100 seconds in the environment model is 100 seconds/10=10 seconds. In other words, one operator can simultaneously operate up to 10 robot models. Thus, a plurality of robots can be efficiently controlled by one operator.

The shortening rate Kscale may be determined on the basis of the frequency of appearance of disturbance elements existing in the work environment of the robot, which is the actual environment. For example, an obstacle having a relatively high possibility of a difference between a predicted observation value and an actual observation value is a disturbance element having a high frequency of appearance. In a case where such a disturbance element having a high frequency of appearance is present, the shortening rate Kscale is set to a small value, so that a long time margin can be ensured from when an abnormality is detected till when the control shifts to real-time control and the operator takes measures against the abnormality.

The shortening rate Kscale may be determined on the basis of the spatial density of disturbance elements existing in the work environment of the robot, which is the actual environment. For example, a work environment in which a relatively large number of obstacles exist is an environment with a high spatial density of disturbance elements. In a case where the spatial density of disturbance elements is high, the shortening rate Kscale is set to a small value, so that a long time margin can be ensured from when an abnormality is detected till when the control shifts to real-time control and the operator takes measures against the abnormality.

The shortening rate Kscale may be determined on the basis of the level of difficulty in coping with the disturbance elements present in the work environment of the robot, which is the actual environment. For example, an obstacle having a relatively drastic change in velocity is a disturbance element having a high level of difficulty in coping. In a case where such a disturbance element having a high level of difficulty in coping is present, the shortening rate Kscale is set to a small value, so that a long time margin can be ensured from when an abnormality is detected till when the control shifts to real-time control and the operator takes measures against the abnormality.

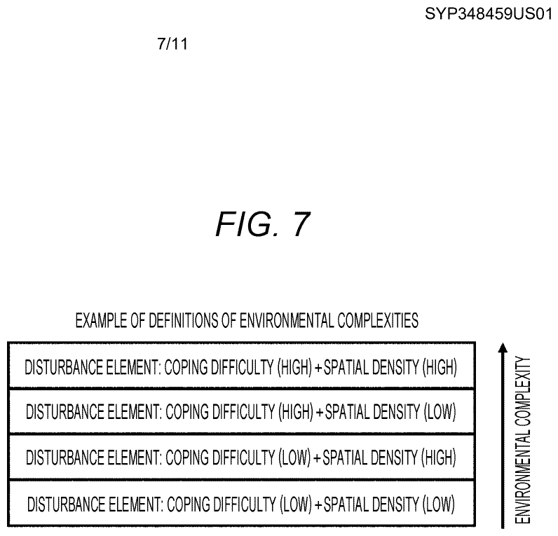

The shortening rate Kscale may be determined on the basis of a combination of the frequency of appearance, the spatial density, and the level of coping difficulty of disturbance elements existing in the work environment of the robot, which is the actual environment. For example, as illustrated in FIG. 7, an environmental complexity based on a combination of the spatial density of and the coping difficulty of disturbance elements may be defined, and the shortening rate Kscale may be determined on the basis of the environmental complexity.

In a case where the robots are household robots (household mobile manipulators) that are operated at a private residence, the shortening rate Kscale may be determined on the basis of an attribute of time at the private residence. Specific examples of attributes of time at a private residence include a parent-and-child going out (daytime on weekdays), a child going out (daytime on holidays), and a parent-and-child going out (nighttime), and the shortening rate Kscale is increased in this order.

In a case where the robots are wheeled-platform robots (wheeled mobile manipulators) that are operated in a factory or a warehouse, the shortening rate Kscale may be determined on the basis of the attribute of the type of the factory or the warehouse. Specific examples of attributes of the type of the factory or the warehouse include an unmanned factory, an unmanned warehouse, a manned factory, and a manned warehouse, and the shortening rate Kscale is increased this order.

In a case where the robots are store robots (store mobile manipulators) that are operated in a retail store, the shortening rate Kscale may be determined on the basis of an attribute of time in the retail store. Specific examples of attributes of time in the retail store include non-business hours, business hours (low season), and business hours (peak season), and the shortening rate Kscale is increased in this order.

In a case where the robots are autonomous driving robots that run on the road, the shortening rate Kscale may be determined on the basis of the attribute of the type of the road on which the robot runs. Specific examples of the attributes of road types include expressway, main road, urban road, private road, and parking lot, and the shortening rate Kscale is increased in this order.

### (Modifications)

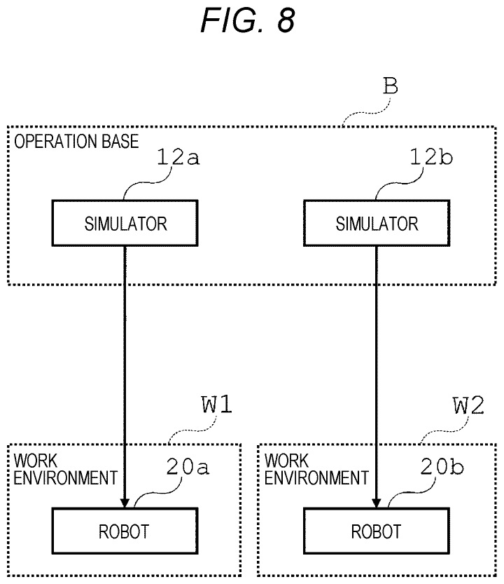

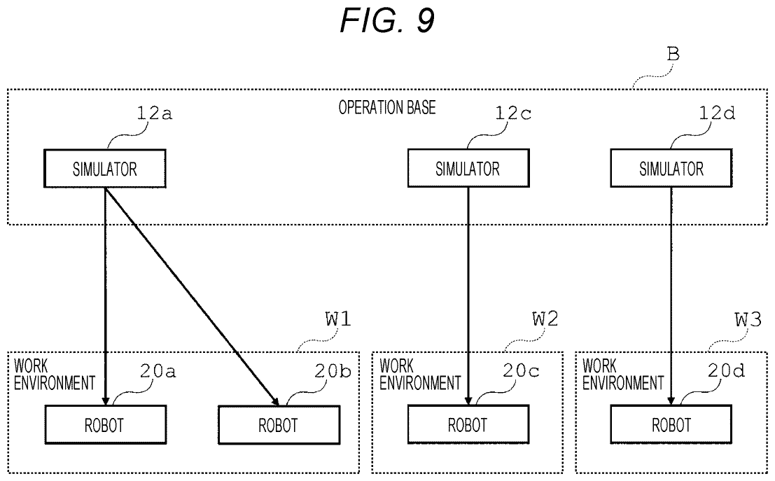

In the first embodiment described above, operations of the two robots 20a and 20b are simulated by the two simulators 12a and 12b, respectively. In other words, the simulators and the robots have one-to-one correspondence, as illustrated in FIG. 8. However, one simulator may simulate operations of a plurality of robots. In other words, a simulator and robots may have one-to-N correspondence. In an example illustrated in FIG. 9, operations of two robots 20a and 20b disposed in the same work environment W1 are simulated by a single simulator 12a. Thus, the calculation resources required for simulations can be saved.

### (Formal Expressions)

To discuss the maximum value of the shortening rate Kscale, a concept that takes into consideration the limit of the reaction rate of the operator is formally expressed. Since there is a limit to the human reaction rate, the shortening rate Kscale of the simulation velocity has a limit at which the operator cannot react.

As described above, the shortening rate Kscale can be expressed as shown below with an actual time Treal that actually elapses in an actual environment, and a simulation time Tsim that elapses in an environment model.

$$\begin{matrix}[ Math . 1 ] & \\ {K}_{scale} = {T}_{sim} / {T}_{real} & ( 1 )\end{matrix}$$

Further, to prevent operations of robots from being hindered, the operator needs to perform an appropriate operation on the corresponding robot after detecting or predicting an abnormality, and thus, be able to recover from the abnormality or avoid the abnormality. This can be expressed as shown below, where Dthr represents the range in which a certain object (a human/object) can give significant disturbance to the robot.

$$\begin{matrix}[ Math . 2 ] & \\ \vert {P}_{follower} ( T ) - {P}_{object} ( T ) \vert \geq {D}_{thr} & ( 2 )\end{matrix}$$

$$where$$

$${P}_{follower} ( T ) = {P}_{{follower}_{T 1}} + {\int }_{t = T 1}^{t = T} {V}_{follower} ( {O}_{opt} ( t ) , t ) dt \qquad ( 3 )$$

$${P}_{object} ( T ) = {P}_{{object}_{T 1}} + {\int }_{t = T 1}^{t = T} {V}_{object} ( t ) dt \qquad ( 4 )$$

Here, in the above expression, the positions of the robot and the object at time T1 when an abnormality is predicted are represented by PfollowerT1 and PobjectT1, respectively, and the positions of the robot and the object at subsequent time t are represented by Pfollower(t) and Pobject(t) while the velocities are represented by Vfollower(Oopt(t), t) and Vobject(t). Further, Oopt(t) indicates appropriate operation details at the time when the operator takes measures against the abnormality.

In practice, an appropriate operation cannot be started immediately after detection of an object. Rather, an appropriate operation is started after a delay time Td, and there is a difference between the simulation time and the actual time according to Expression (1). Therefore, making the shortening rate Kscale as high as possible within a range that does not interfere with the operation of the robot will result in the problems described below.

$$\begin{matrix}[ Math . 3 ] & \\ Maximize : {K}_{scale} & \end{matrix}$$

$$s . t .$$

$$\vert {P}_{follower}^{′′′} ( T , {K}_{scale} ) - {P}_{object} ( T ) \vert \geq {D}_{thr}$$

$$T \geq T 1$$

$$where$$

$${P}_{follower}^{′} ( T , K ) = {P}_{{follower}_{T 1}} + {\int }_{t = T 1}^{t = T 1 + {KT}_{d}} {V}_{follower} ( {O}_{prev} ( t ) , t ) dt + {\int }_{t = T 1 + {KT}_{d}}^{t = T} {V}_{follower} ( {O}_{opt} ( t ) , t ) dt$$

$${P}_{object} ( T ) = {P}_{object \_ T 1} + {\int }_{t = T 1}^{t = T} {V}_{object} ( t ) dt$$

### Specific Example: Autonomous Driving Robot

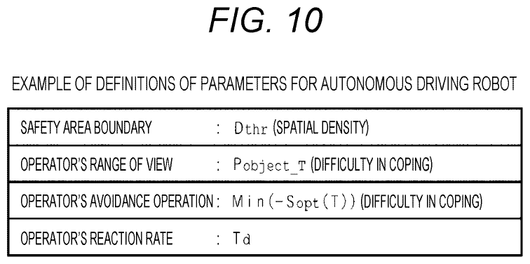

In an autonomous driving robot whose velocity is controlled by an operator, parameters such as the size of the safety area (safety area boundary), the range of view of the operator, the avoidance operation to be performed by the operator, and the reaction rate of the operator are defined as shown in FIG. 10.

Using the parameters shown in FIG. 10, the above Expressions (3) and (4) can be specifically written as follows.

$$\begin{matrix}[ Math . 4 ] & \\ {Pv}_{follower} ( T , K ) = {P}_{{follower}_{T 1}} + {\int }_{t = T 1}^{t = T 1 + {KT}_{d}} {V}_{follower \_ prev} ( t ) dt + {\int }_{t = T 1 + {KT}_{d}}^{t = T} {V}_{follower \_ opt} ( t ) dt \leq {P}_{{follower}_{T 1}} + {KT}_{d} {O}_{max} + {\int }_{t = T 1 + {KT}_{d}}^{t = T} {O}_{opt} ( t ) dt & \end{matrix}$$

$${Pv}_{object} ( T ) = {P}_{object \_ T 1} + ( T - T 1 ) {V}_{object \_ max}$$

The respective values of the parameters in FIG. 10 can be set on the basis of the attribute of the road type, such as expressway, main road, or urban road, for example. Further, the object is a movable carriage, and a collision with an oncoming vehicle (object) is assumed to be abnormal. At this point of time, if an operation to change the traveling direction is not to be performed before the operator notices an abnormality, Omax represents a positive constant. Further, if the oncoming vehicle is in front of the operation target robot (car), P′follower(T, Kscale)<Pobject(T), and the constraint expression can be modified as follows.

$$\begin{matrix}[ Math . 5 ] & \\ - ( {Pv}_{follower}^{″} ( T , {K}_{scale} ) + {KT}_{d} {O}_{max} - {Pv}_{object} ( T ) ) \geq {D}_{thr} & \end{matrix}$$

$$- {Pv}_{follower}^{′} ( T , {K}_{scale} ) + {KT}_{d} {O}_{max} - {Pv}_{object} ( T ) \geq {D}_{thr}$$

$$- {Pv}_{follower}^{′} ( T , {K}_{scale} ) + {KT}_{d} {O}_{max} + ( {P}_{object \_ T 1} + ( T - T 1 ) {V}_{object \_ max} ) \geq {D}_{thr}$$

$${Pv}_{follower}^{′} ( T , {K}_{scale} ) \leq - {D}_{thr} - {KT}_{d} {O}_{max} + ( {P}_{object \_ T 1} + ( T - T 1 ) {V}_{object \_ max} )$$

$$where$$

$${Pv}_{follower}^{′} ( T , K ) = {P}_{follower \_ T 1} + {\int }_{t = T 1 + {KT}_{d}}^{t = T} {O}_{opt} ( t ) dt$$

Here, the indefinite integral of Oopt(t) is defined as Sopt(t), and is decomposed into the form of a definite integral, to obtain the following.

$$\begin{matrix}[ Math . 6 ] & \\ {Pv}_{follower}^{′} ( T , K ) = {P}_{follower \_ T 1} + {[ {S}_{opt} ( t ) ]}_{T 1 + {KT}_{d}}^{T} = {P}_{follower \_ T 1} + {S}_{opt} ( T ) - {S}_{opt} ( T 1 + {KT}_{d} ) & \end{matrix}$$

Here, it is assumed that an operation to go straight toward the object or not to change the traveling direction is performed until the operator performs an optimum operation. Accordingly, Sopt(T1+KTd)=Omax (T1+KTd), and the following relationship holds.

$$\begin{matrix}[ Math . 7 ] & \\ {P}_{follower \_ T 1} + {S}_{opt} ( T ) + {O}_{max} ( T 1 + {KT}_{d} ) \leq {Pv}_{follower}^{′} ( T , K ) \leq {P}_{follower \_ T 1} + {S}_{opt} ( T ) + {O}_{max} ( T 1 + {KT}_{d} ) & \end{matrix}$$

When this relationship is applied to the above constraint expression, the following is obtained.

$$\begin{matrix}[ Math . 8 ] & \\ {P}_{follower \_ T 1} + {S}_{opt} ( T ) + {O}_{max} ( T 1 + {KT}_{d} ) \leq {D}_{thr} - {KT}_{d} {O}_{max} + ( {P}_{object \_ T 1} + ( T - T 1 ) {V}_{object \_ max} ) & ( 5 )\end{matrix}$$

$${O}_{max} ( T 1 + {KT}_{d} ) + {KT}_{d} {O}_{max} \leq - {D}_{thr} + ( {P}_{object \_ T 1} + ( T - T 1 ) {V}_{object \_ max} ) - {P}_{follower \_ T 1} - {S}_{opt} ( T )$$

$$2 {KT}_{d} {O}_{max} \leq - {D}_{thr} + ( {P}_{{object}_{T 1}} + ( T - T 1 ) {V}_{object \_ max} ) - {P}_{{follower}_{T 1}} - {S}_{opt} ( T ) - {O}_{max} T 1$$

$$K \leq \frac{\begin{matrix}- {D}_{thr} + ( {P}_{{object}_{T 1}} + ( T - T 1 ) {V}_{object \_ max} ) - \\ {P}_{{follower}_{T 1}} - {S}_{opt} ( T ) - {O}_{max} T 1\end{matrix}}{2 {T}_{d} {O}_{max}}$$

$$G ( T ) = \frac{- {D}_{thr} + ( {P}_{{object}_{T 1}} + ( T - T 1 ) {V}_{object \_ max} ) - {S}_{opt} ( T ) - {O}_{max} T 1}{2 {T}_{d} {O}_{max}} = \frac{- {D}_{thr} + ( {P}_{{object}_{T 1}} + ( T - T 1 ) {V}_{object \_ max} ) - {S}_{opt} ( T )}{2 {T}_{d} {O}_{max}} - \frac{T 1}{2 {T}_{d}}$$

$$G 2 ( T ) = \frac{- {D}_{thr} + ( {P}_{{object}_{T 1}} + ( T - T 1 ) {V}_{object \_ max} ) + Min ( - {S}_{opt} ( T ) )}{2 {T}_{d} {O}_{max}} - \frac{T 1}{2 {T}_{d}}$$

$$K \leq G 2 ( T ) \leq G ( T )$$

In particular, where T1=0, the following is obtained.

$$\begin{matrix}[ Math . 9 ] & \\ G 2 ( T ) = \frac{- {D}_{thr} + ( {P}_{{object}_{T 1}} + {TV}_{object \_ max} ) + Min ( - {S}_{opt} ( T ) )}{2 {T}_{d} {O}_{max}} & \end{matrix}$$

Here, if Dthr=2.0 m, Vobject_max=Omax=maximum operation speed, and Td=0.1 seconds, G2(T) is as follows.

$$\begin{matrix}[ Math . 10 ] & \\ G 2 ( T ) = \frac{- 2. + ( {P}_{{object}_{T 1}} + {TV}_{object \_ max} ) + Min ( - {S}_{opt} ( T ) )}{0.2 \times {O}_{max}} & \end{matrix}$$

Since time T is later than T1, and T1=0, the value range is expressed as T≥T1=0. Accordingly, the maximum value that K can take is G2(0) according to Expression (5).

$$\begin{matrix}[ Math . 11 ] & \\ G 2 ( 0 ) = \frac{\frac{K \leq G 2 ( 0 ) \leq G 2 ( T ) \leq G ( T )}{- 2. + {P}_{{object}_{T 1}} + Min ( - {S}_{opt} ( T ) )}}{0.2 \times {O}_{max}} & \end{matrix}$$

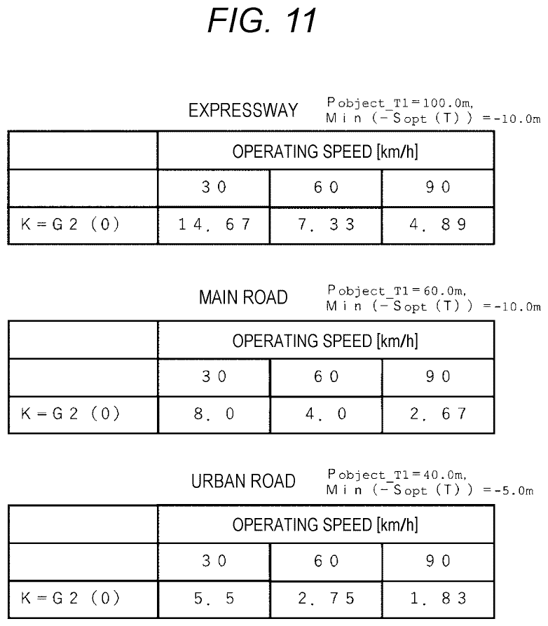

When G2(0) is calculated for an expressway, a main road, and an urban road, the results are as shown in FIG. 11.

Although some embodiments have been described, these embodiments have been presented as examples and are not intended to limit the scope of embodiments. These embodiments can be implemented in various other modes, and various omissions, substitutions, changes, and combinations can be made without departing from the gist of embodiments. These embodiments and modifications thereof are included in the scope and gist of embodiments, and are included in the claims and the equivalents thereof.

Note that the technology according to the present disclosure is not limited to a specific standard, and the exemplified settings may be changed as appropriate. Note that each of the above embodiments illustrates an example for embodying the present disclosure, and the present disclosure can be implemented in other various modes. For example, various modifications, substitutions, omissions, combinations, and the like can be made without departing from the gist of the present disclosure. Such modifications, substitutions, omissions, combinations, and the like are also included in the scope of the present disclosure, and are included in the invention disclosed in the claims and the equivalent scope thereof.

Further, the procedures of processing described in the present disclosure may be regarded as a method including a series of these procedures. Alternatively, the procedures may be regarded as a program for causing a computer to carry out the series of these procedures, or as a recording medium storing the program. Also, the processing described above is performed by a processor such as the CPU of the computer. Furthermore, the type of the recording medium does not affect embodiments of the present disclosure, and therefore, is not limited to any particular type.

Note that each of the components illustrated in the present disclosure may be realized by software, or may be realized by hardware. For example, each component may be a software module realized by software such as a microprogram, and each component may be realized by a processor executing the software module. Alternatively, each component may be realized by a circuit block on a semiconductor chip (die), or an integrated circuit such as an application specific integrated circuit (ASIC) or a field programmable gate array (FPGA), for example. Further, the number of components and the number of pieces of hardware for realizing the components may not coincide with each other. For example, one processor or circuit may realize a plurality of components. Conversely, one component may be realized by a plurality of processors or circuits.

Note that the processor mentioned in the present disclosure is not limited to any particular type. For example, the processor may be a CPU, a micro processing unit (MPU), a graphics processing unit (GPU), or the like.

Note that the present disclosure can also provide configurations as described below.

### [1] (a Control Method for a Plurality of Robots)

A method for controlling a plurality of robots, the method including:
a step of receiving an operation command for the plurality of robots from an operator (S11);
a step of using a plurality of robot models and an environment model corresponding the plurality of robots, causing the plurality of robot models to operate in the environment model at a higher speed than actual time on the basis of the operation command, and acquiring a predicted observation value obtained as a result (S12);
a step of displaying the predicted observation value toward the operator (S13);
a step of accumulating task information including the operation command and the predicted observation value (S14); and
a step of transmitting the accumulated task information to the plurality of robots (S16).
   [2]

The method according to [1], further including:
a step of receiving the task information (S21);
a step of accumulating the received task information (S22); and
a step of causing the plurality of robots to operate in an actual environment, in accordance with the operation command included in the accumulated task information (S23).
   [3]

The method according to [2], further including:
a step of acquiring an actual observation value obtained as a result of causing the plurality of robots to operate in the actual environment (S24); and
a step of detecting an abnormality, on the basis of a comparison between the predicted observation value and the actual observation value (S25).
   [4]

The method according to [3], further including a step of, when the abnormality is detected, shifting control on the robot having the abnormality detected, to real-time control to be performed by the operator.

[5]

The method according to any one of [1] to [4], in which a relationship expressed as

$$shortening rate Kscale = Tsim / Treal$$

holds between the actual time Treal being felt by the operator and a simulation time Tsim that elapses in the environment model, and the shortening rate Kscale is a real number of 1 or greater.
   [6]

The method according to [5], in which the shortening rate is determined on the basis of at least one of a frequency of appearance, a spatial density, or a coping difficulty of a disturbance element existing in the actual environment.

[7]

The method according to [5], in which the robot is a household robot to be operated at a private residence, and the shortening rate is determined on the basis of an attribute of time at the private residence.

[8]

The method according to [5], in which the robot is a wheeled-platform robot to be operated in one of a factory or a warehouse, and the shortening rate is determined on the basis of an attribute of a type of the factory or the warehouse.

[9]

The method according to [5], in which the robot is a store robot to be operated in a store, and the shortening rate is determined on the basis of an attribute of time in the store.

[10]

The method according to [10], in which the robot is an autonomous driving robot that runs on a road, and the shortening rate is determined on the basis of an attribute of a type of the road.

[11] (A control device for a plurality of robots) A device that controls a plurality of robots, the device including:
an input unit (11) that receives an operation command for a plurality of robots (20a, 20b) from an operator (1);
a simulation unit (12) that includes a plurality of robot models (121a, 121b) and an environment model (122a, 122b) corresponding to the plurality of robots, causes the plurality of robot models to operate in the environment model at a higher speed than actual time on the basis of the operation command, and outputs a predicted observation value obtained as a result;
a display unit (13) that displays the predicted observation value toward the operator;
an accumulation unit (14a, 14b) that accumulates task information including the operation command and the predicted observation value; and
a transmission unit (15) that transmits the task information accumulated in the accumulation unit to the plurality of robots.
   [12]

The device according to [11], in which the simulation unit includes a plurality of simulators (12a, 12b), and
each simulator of the plurality of simulators simulates an operation of at least one robot model of the plurality of robot models.

### [13] (a Control System for a Plurality of Robots)

A system that controls a plurality of robots, the system including
the plurality of robots (20a, 20b), and a control device (10) for the plurality of robots, in which
the control device includes:
an input unit (11) that receives an operation command for the plurality of robots from an operator (1);
a simulation unit (12) that includes a plurality of robot models (121a, 121b) and an environment model (122a, 122b) corresponding to the plurality of robots, simulates an operation of the plurality of robot models in the environment model at a higher speed than actual time on the basis of the operation command, and outputs a predicted observation value obtained as a result;
a display unit (13) that displays the predicted observation value toward the operator;
a first accumulation unit (14a, 14b) that accumulates task information including the operation command and the predicted observation value; and
a transmission unit (15) that transmits the task information accumulated in the first accumulation unit to the plurality of robots, and
each robot of the plurality of robots includes:
a reception unit (21a, 21b) that receives the task information from the control device;
a second accumulation unit (22a, 22b) that accumulates the task information received by the reception unit; and
a control unit (23a, 23b) that causes the robot to operate in an actual environment, in accordance with the operation command included in the task information accumulated in the second accumulation unit.

### REFERENCE SIGNS LIST

1 Operator
10 Control device
11 Input unit
12 Simulation unit
12a Simulator
12b Simulator
12c Simulator
12d Simulator
13 Display unit
14a Accumulation unit
14b Accumulation unit
15 Transmission unit
16 Reception unit
20a Robot
20b Robot
20c Robot
20d Robot
21a Reception unit
21b Reception unit
22a Accumulation unit
22b Accumulation unit
23a Control unit
23b Control unit
24a Driving motor
24b Driving motor
25a Internal sensor
25b Internal sensor
26a External sensor
26b External sensor
27a Abnormality detection unit
27b Abnormality detection unit
100 Control system
121a Robot model
121b Robot model
122a Environment model
122b Environment model
B Operation base
W1 Work environment
W2 Work environment
W3 Work environment

1. A method for controlling a plurality of robots, the method comprising:
a step of receiving an operation command for the plurality of robots from an operator;
a step of using a plurality of robot models and an environment model corresponding the plurality of robots, causing the plurality of robot models to operate in the environment model at a higher speed than actual time on a basis of the operation command, and acquiring a predicted observation value obtained as a result;
a step of displaying the predicted observation value toward the operator;
a step of accumulating task information including the operation command and the predicted observation value; and
a step of transmitting the accumulated task information to the plurality of robots.

2. The method according to claim 1, further comprising:
a step of receiving the task information;
a step of accumulating the received task information; and
a step of causing the plurality of robots to operate in an actual environment, in accordance with the operation command included in the accumulated task information.

3. The method according to claim 2, further comprising:
a step of acquiring an actual observation value obtained as a result of causing the plurality of robots to operate in the actual environment; and
a step of detecting an abnormality, on a basis of a comparison between the predicted observation value and the actual observation value.

4. The method according to claim 3, further comprising a step of, when the abnormality is detected, shifting control on the robot having the abnormality detected, to real-time control to be performed by the operator.

5. The method according to claim 1, wherein a relationship expressed as
$$shortening rate Kscale = Tsim / Treal$$
holds between the actual time Treal being felt by the operator and a simulation time Tsim that elapses in the environment model, and the shortening rate Kscale is a real number of 1 or greater.

6. The method according to claim 5, wherein the shortening rate is determined on a basis of at least one of a frequency of appearance, a spatial density, or a coping difficulty of a disturbance element existing in the actual environment.

7. The method according to claim 5, wherein the robot includes a household robot to be operated at a private residence, and the shortening rate is determined on a basis of an attribute of time at the private residence.

8. The method according to claim 5, wherein the robot includes a wheeled-platform robot to be operated in one of a factory or a warehouse, and the shortening rate is determined on a basis of an attribute of a type of the factory or the warehouse.

9. The method according to claim 5, wherein the robot includes a store robot to be operated in a store, and the shortening rate is determined on a basis of an attribute of time in the store.

10. The method according to claim 5, wherein the robot includes an autonomous driving robot that runs on a road, and the shortening rate is determined on a basis of an attribute of a type of the road.

11. A device that controls a plurality of robots, the device comprising:
an input unit that receives an operation command for a plurality of robots from an operator;
a simulation unit that includes a plurality of robot models and an environment model corresponding to the plurality of robots, causes the plurality of robot models to operate in the environment model at a higher speed than actual time on a basis of the operation command, and outputs a predicted observation value obtained as a result;
a display unit that displays the predicted observation value toward the operator;
an accumulation unit that accumulates task information including the operation command and the predicted observation value; and
a transmission unit that transmits the task information accumulated in the accumulation unit to the plurality of robots.

12. The device according to claim 11, wherein the simulation unit includes a plurality of simulators, and
each simulator of the plurality of simulators simulates an operation of at least one robot model of the plurality of robot models.

13. A system that controls a plurality of robots, the system comprising
the plurality of robots, and a control device for the plurality of robots, wherein
the control device includes:
an input unit that receives an operation command for the plurality of robots from an operator;
a simulation unit that includes a plurality of robot models and an environment model corresponding to the plurality of robots, simulates an operation of the plurality of robot models in the environment model at a higher speed than actual time on a basis of the operation command, and outputs a predicted observation value obtained as a result;
a display unit that displays the predicted observation value toward the operator;
a first accumulation unit that accumulates task information including the operation command and the predicted observation value; and
a transmission unit that transmits the task information accumulated in the first accumulation unit to the plurality of robots, and
each robot of the plurality of robots includes:
a reception unit that receives the task information from the control device;
a second accumulation unit that accumulates the task information received by the reception unit; and
a control unit that causes the robot to operate in an actual environment, in accordance with the operation command included in the task information accumulated in the second accumulation unit.
